(19) United States
(12) Patent Application Publication
(10) Pub. No.: US 2010/0287387 A1
(43) Pub. Date: Nov. 11, 2010

(54) Docking station

(76) Inventor: Johnny Hsiang-Yu Chen, Anaheim, CA (US)

Correspondence Address: LAMBERT & ASSOCIATES, 92 STATE STREET, BOSTON, MA, 02109-2004, US

(21) Appl. No.: 12/462,170

(22) Filed: Jul. 30, 2009

Related U.S. Application Data
(60) Provisional application No. 61/215,691, filed on May 8, 2009.

(51) Int. Cl. G06F 13/00; G06F 1/26

(52) U.S. Cl. 713/300; 710/303

(57) ABSTRACT

A portable computer has a downstream USB 2.0 port, connected to a docking station of the invention via a USB cable having a Type A plug in the port and a Type B plug plugged into an upstream port in the docking station. This has a housing, in which is mounted hub circuitry, connected to the upstream port, a hard drive and a plurality of downstream ports. Peripheral devices are plugged into the ports. Thus the computer can enumerate and communicate with the hard drive and the peripheral devices.

The peripheral device is touch-screen visual-display unit connected via a lead to a plug; whilst the peripheral devices are modules having internal circuitry with a plastics material case, which supports pin contacts in a rectangular array. Certain of the modules have antennae to enable them to communicate wirelessly.

### CROSS REFERENCE TO RELATED APPLICATION

This application takes priority from and claims the benefit of Provisional Application Ser. No. 61/215,691 filed on May 8, 2009 the contents of which are hereby incorporated by reference.

### BACKGROUND OF THE INVENTION

1. Field of the Invention

The present invention relates to a docking station for a host computer.

2. Description of the Related Art

As used herein the term “docking station” means a peripheral device having a plurality of ports, which may or may not be of the same type, via which the computer can communicate with other peripheral devices. Docking stations were introduced shortly after laptop computers so that a multiplicity of connections could be made in a single operation, without the need to plug several cables into the computer. Generally they comprised a substantial base onto which the computer was placed and locked in position, with a single multi-contact connection being made. The computer could be unlocked for use remote from the docking station. Contact was provided amongst other things for a power supply to the computer.

Connection was two way in that not only could data be down-loaded as to a printer, it could be up-loaded as well as from a mouse, a keyboard separate from that of the laptop and a network cable.

As laptop computers developed, docking stations, which were expensive, became less popular. At the same time, USB—Universal Serial Bus—connection became available, whereby connection to many peripheral devices became possible via a single cable and a hub, that is to say a peripheral device having a single cable connection with a computer and a plurality of connections with peripheral devices. Where these hubs included dedicated mouse and keyboard ports, they were variously known as port replicators or docking stations, since they replicated conventional ports provided on the computer and provided the functions of a docking station, except that they were not physically locked to the computer in the way that original docking stations were.

As used herein the term “docking station” is used to mean a hub or port replicator without necessarily any physical connection with a host computer, but providing at least one port for connection to other peripheral devices. Again, one or more peripheral device may be incorporated within the docking station.

As laptops have developed, they have become smaller. A laptop of the latest generation is not known as a laptop at all, but a “netbook”. It is intended primarily for wireless web browsing. It does not have a hard drive. It can benefit from a docking station to increase its flexibility when being used in the office. For the avoidance of doubt, netbook docking stations are available. Further for the avoidance of doubt, we refer to laptop and netbook computers, which have their own batteries, as “portable computers”.

Peripheral devices, such as a flash memory module or a CWUSB module or a telephone module which are pluggable into a docking station or indeed a computer are referred to herein as pluggable peripheral modules. Prior such modules have usually been provided with a USB Type A plug.

### SUMMARY OF THE INVENTION

The object of the present invention is to provide an improved docking station for a host computer which will normally be a portable computer.

According to one aspect of the invention there is provided a docking station for a host computer comprising:
an upstream, serial-bus means for data-connection with the host computer;
at least one downstream, serial-bus port provided with:
   a pair of data connectors,
   a pre-determined voltage connector,
   at least one lower voltage connector and
   a ground connector;
power supply means for providing the lower voltage(s) to its voltage connector(s) for use downstream.

Normally the pre-determined voltage will be 5.0 volts, which is the standard USB voltage. However it could be 3.3 volts, another standard voltage increasingly used. The lower voltage will be chosen in accordance with the processing chip or chips to be used in a downstream pluggable peripheral module. This may be 3.3 volts (where the predetermined voltage is 5.0 volts) or alternatively any one or more of 2.5, 2.2, 1.8, 1.0, 0.9 and 0.7 volts.

The upstream, serial-bus data-connection means can be a wireless serial-bus connection, in particular using the standard Certified Wireless USB protocol. In this case, the docking station will be provided with its own power supply, for powering:
peripheral devices which it will normally be provided with, such as a hard drive, together with,
interface devices for the or each downstream serial-bus port,
the downstream power supply means and
a possible conventional USB port enabling the user to use his existing USB peripherals.

Alternatively, the upstream serial bus data connection can be a wired USB connection via a USB cable, that is to say the upstream serial bus data connection preferably comprises:
an upstream USB port provided with:
   a pair of data connectors,
   a 5.0 volts connector and
   a ground connector.

Insofar as this USB port—typically a USB2.0 port—will provide 5.0 volts to the docking station, it may provide power for the docking station as such. However, where the docking station is provided with a plurality of downstream ports and/or one or more peripheral devices, it is preferable to provide the docking station with its own power supply.

According to another aspect of the invention there is provided a serial-bus pluggable peripheral device including:
data handling and/or data storage means and
connection means complementary to the downstream serial-bus port of the docking station, the complementary connection means comprising:
   a pair of complementary data connectors,
   a pre-determined voltage complementary connector,
   at least one lower voltage complementary connector and
   a ground complementary connector.

Normally, the pluggable peripheral device will be a self-contained module, typically having its circuitry housed in a single casing to which its connectors are attached. However, some pluggable peripheral devices can include:

a plug having the complementary connectors,

a lead and

the device per se at the remote end of the lead.

Typically such device could be a touch-sensitive, visual-display unit.

Preferably the connectors and the complementary connectors are pins and sockets.

The ports can be provided with male pins, but are preferably provided with female sockets, with the complementary connectors being pins.

In preferred embodiments, the or each downstream, serial-bus port has the following contact numbering:

1. Ground

2. Serial Bus data +ve

3. Serial Bus data −ve

4. Ground

5. 3.3 volts

6. 2.5 volts

7. 2.2 volts

8. 1.8 volts

9. 1.2 volts

10. 1.0 volts

11. 0.9 volts

12. 0.7 volts

13. Spare

14. 5.0 volts.

The pluggable peripheral modules are preferably provided with contact sockets 1 to 4 and 5 or 14, together with anyone of contact sockets 6 to 12 as required for voltage to operate their electronic device(s). Nevertheless, it is conceivable that contact sockets 1 to 4 together with 14 only or 5 only may be provided, where the circuitry of the module does not require a voltage lower than the predetermined voltage.

It will be appreciated that provision of the power supply for the downstream power supply in the docking station, enables to the pluggable peripheral modules to simple without the'need for their own power supplies.

### BRIEF DESCRIPTION OF THE DRAWINGS

To help understanding of the invention, a specific embodiment thereof will now be described by way of example and with reference to the accompanying drawings, in which:

FIG. 1 is a diagrammatic perspective view of a portable computer connected to a docking station of the invention and pluggable peripheral modules of the invention;

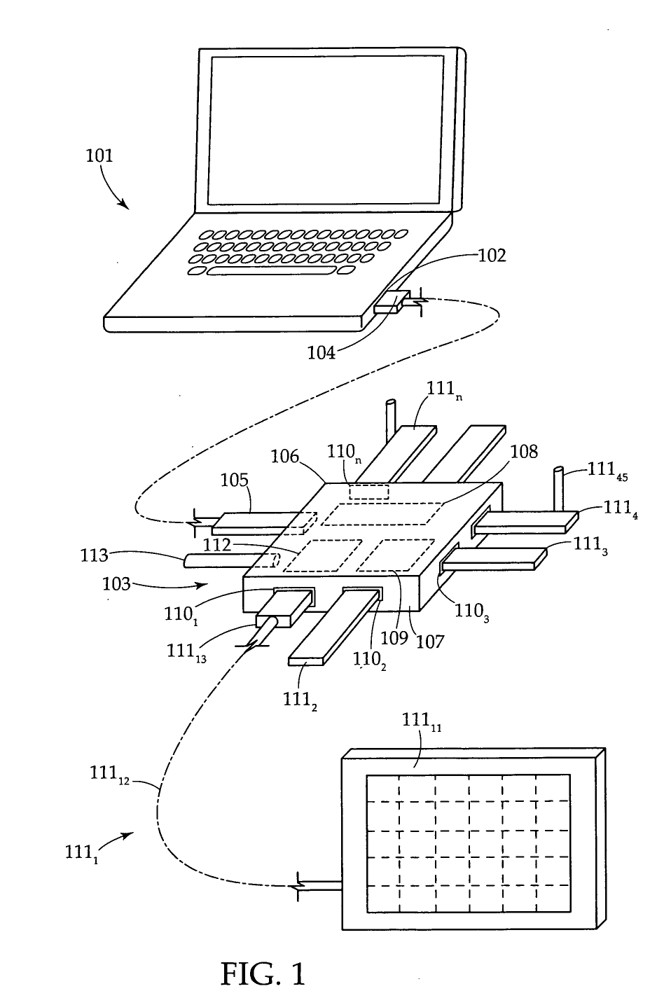

FIG. 2 is a scrap view of a down stream port of the docking station of FIG. 1;

FIG. 3 is a diagrammatic perspective view of a pluggable peripheral module of to the invention; and

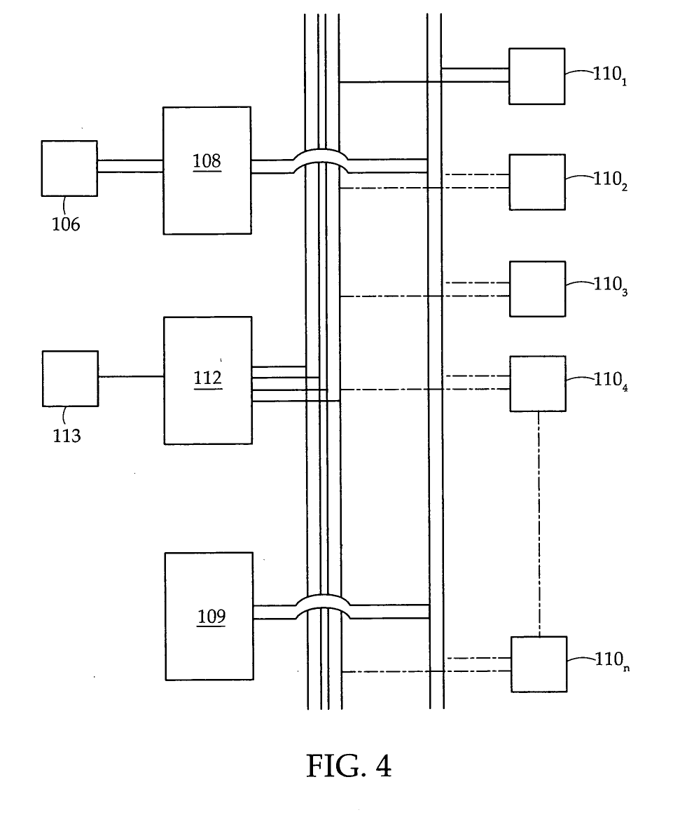

FIG. 4 is a block diagram of the circuitry of the docking station.

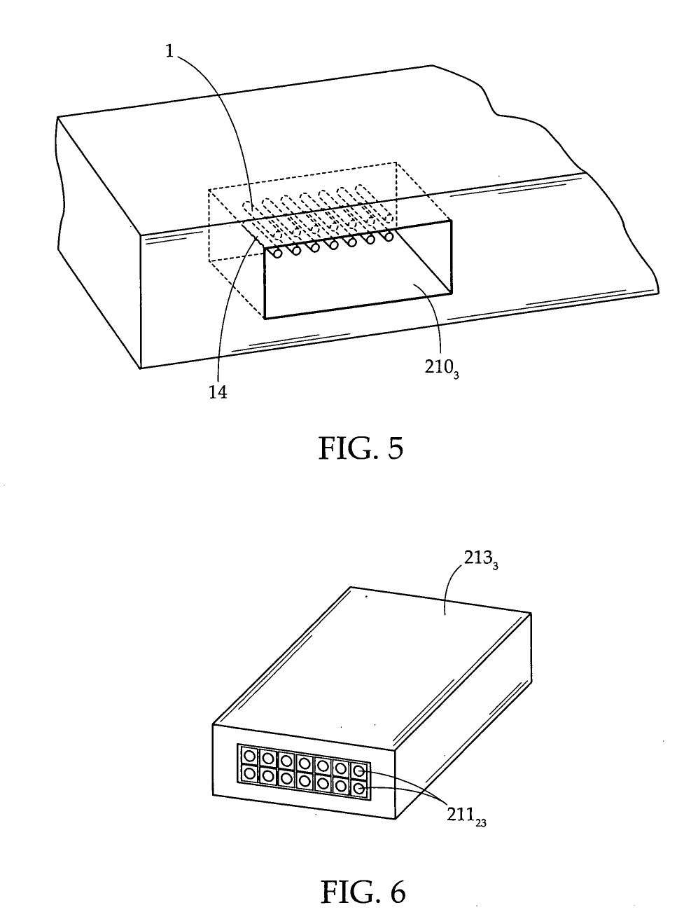

### DETAILED DESCRIPTION OF THE PREFERRED EMBODIMENT

Referring to the drawings, a portable computer 101 has a downstream USB 2.0 port 102, connected to a docking station 103 of the invention via a USB cable having a Type A plug 104 in the port 102 and a Type B plug 105 plugged into an upstream port 106 in the docking station. This has a housing 107, in which is mounted hub circuitry 108, connected to the upstream port 106, a hard drive 109 and a plurality of downstream ports 110₁, 110₂, . . . 110ₙ₋₁, 110ₙ. Peripheral devices 111₁, 111₂, . . . 111ₙ₋₁, 111ₙ are plugged into the ports 110₁, 110₂, . . . 110ₙ₋₁, 110ₙ. Thus the computer can enumerate and communicate with the hard drive 109 and the peripheral devices 111₁, 111₂, . . . 111ₙ₋₁, 111ₙ.

The peripheral device 111₁ is touch-screen visual-display unit 111₁₁ connected via a lead 111₁₂ to a plug 111₁₃; whilst the peripheral devices 111₂, . . . 111ₙ₋₁ are modules having internal circuitry 111₂₁ with a plastics material case 111₂₂, which supports pin contacts 111₂₃ in a rectangular array 111₂₄. Certain of the modules have antennae 111₄₅ to enable them to communicate wirelessly. Typically, the circuitry will include circuitry for modulating a data stream onto a carrier frequency, which will use low voltage components and oscillation and transceiver circuitry which will use a higher voltage. These voltages will be supplied to the circuitry by respective ones of the socket contacts 111₂₃. The port 110ₙ is a conventional USB2.0 port enabling a conventional USB module 111ₙ, which the user may have already possessed, to be used.

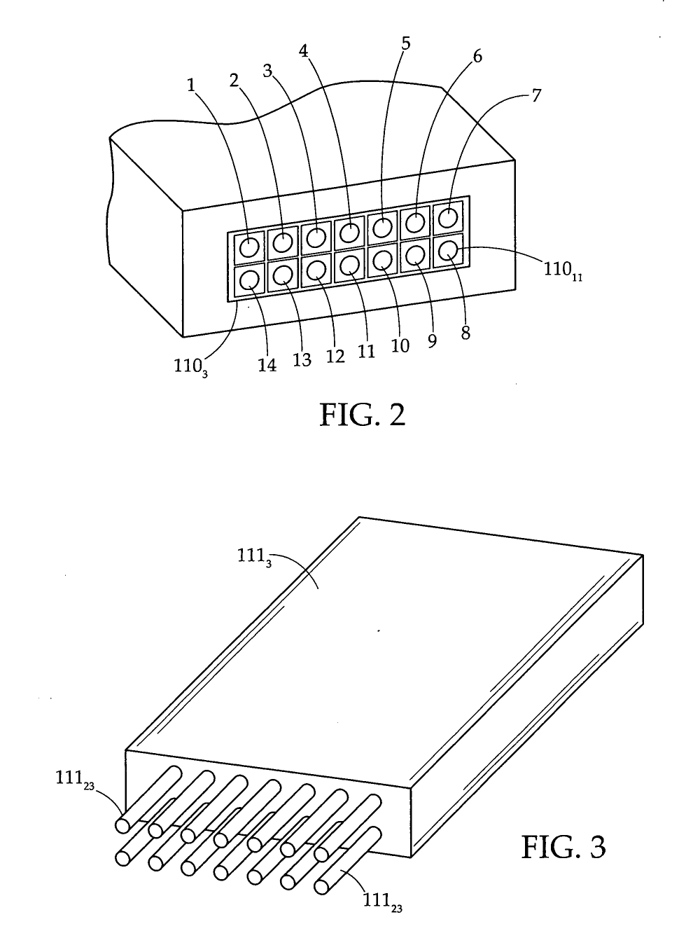

The downstream ports 110₁, 110₂, . . . 110ₙ₋₁ have socket contacts 110₁₁ arranged in a seven by two rectangular array as shown in FIG. 2. They are arranged as shown in page 4 above, with the data socket contacts being connected to the hub circuitry 108 and the voltage socket contacts being connected to a power supply 112 in the docking station. This is powered from an external power source (not shown) via a jack plug socket 113. The power supply is arranged to be powered down and not supplying power to the downstream ports in the absence of a voltage received from the upstream USB port 106. On detection of this the respective voltages are supplied to the socket contacts 110₁₁.

The peripheral modules 111₂, . . . 111ₙ₋₁ have only those of the 14 possible supports pin contacts 111₂₃ provided in their plugs 111₂₆ such as to enable data and the voltages that they require for operation to be supplied.

The invention is not intended to be restricted to the details of the above described embodiment. For instance, docking station may be provided with additional peripherals either permanently or as plug in modules. For instance a DVD drive can be built into the housing or a slot for one may be provided.

Further as shown in the FIGS. 5 and 6, the pins and sockets can be reversed. As shown in FIG. 5, the port 210₃ is provided with pins 1 to 14 at the bottom of a socket of sufficient depth to protect them from damage or short circuit in the event of brushing of an object across the mouth of the port. The module 213₃ is provided with socket contacts 211₂₃ in a complementary rectangular array. The contacts as such are provided only at certain of the positions, in accordance with the voltage requirements of the module.

I claim:

1. A docking station for a host computer comprising:
an upstream, serial-bus means for data-connection with the host computer;
at least one downstream, serial-bus port provided with:
a pair of data connectors,
a pre-determined voltage connector,
at least one lower voltage connector and
a ground connector;
power supply means for providing the lower voltage(s) to its voltage connector(s) for use downstream.

2. A docking station according to claim 1, wherein the pre-determined voltage is 5.0 volts.

3. A docking station according to claim 1, wherein the pre-determined voltage is the standard USB voltage.

4. A docking station according to claim 1, wherein the pre-determined voltage is 3.3 volts.

5. A docking station according to claim 1, wherein the lower voltage is chosen from the group comprising 3.3, 2.5, 2.2, 1.8, 1.0, 0.9 and 0.7 volts.

6. A docking station according to claim 1, wherein the upstream, serial-bus data-connection means is a wireless serial-bus connection.

7. A docking station according to claim 6, wherein the wireless serial-bus connection is adapted and arranged to use the standard Certified Wireless USB protocol.

8. A docking station according to claim 6, including its own power supply, for powering downstream devices.

9. A docking station according to claim 6, including:
its own power supply for the downstream power supply means,
peripheral devices, with which it is provided and which are powered by its own power supply,
interface devices for the or each downstream serial-bus port, with which it is provided and which are powered by its own power supply.

10. A docking station according to claim 9, including a conventional USB port.

11. A docking station according to claim 1, wherein the upstream serial bus data connection is a wired USB connection connectable via a USB cable.

12. A docking station according to claim 11, wherein the wired USB connection comprises:
an upstream USB port provided with:
a pair of data connectors,
a 5.0 volts connector and
a ground connector.

13. A docking station according to claim 12, wherein docking station is adapted and arranged to be powered from the 5.0 volts connector.

14. A docking station according to claim 11, including its own power supply, for powering downstream devices.

15. A docking station according to claim 14, including:
its own power supply for the downstream power supply means,
peripheral devices, with which it is provided and which are powered by its own power supply,
interface devices for the or each downstream serial-bus port, with which it is provided and which are powered by its own power supply.

16. A docking station according to claim 15, including a conventional USB port.

17. A docking station according to claim 1, wherein the or each downstream, serial-bus port has the following contact numbering:
1. Ground
2. Serial Bus data +ve
3. Serial Bus data −ve
4. Ground
5. 3.3 volts
6. 2.5 volts
7. 2.2 volts
8. 1.8 volts
9. 1.2 volts
10. 1.0 volts
11. 0.9 volts
12. 0.7 volts
13. Spare
14. 5.0 volts.

18. A serial-bus pluggable peripheral device for use with a docking station for a host computer comprising:
an upstream, serial-bus means for data-connection with the host computer;
at least one downstream, serial-bus port provided with:
a pair of data connectors,
a pre-determined voltage connector,
at least one lower voltage connector and
a ground connector;
power supply means for providing the lower voltage(s) to its voltage connector(s) for use downstream.
the serial-bus pluggable peripheral device including:
data handling and/or data storage means and
connection means complementary to the downstream serial-bus port of the docking station, the complementary connection means comprising:
a pair of complementary data connectors,
a pre-determined voltage complementary connector,
at least one lower voltage complementary connector and
a ground complementary connector.

19. A pluggable peripheral device according to claim 18, wherein the device is a self-contained module, having its circuitry housed in a single casing to which its connectors are attached.

20. A pluggable peripheral device according to claim 19, wherein the circuitry of the device is devoid of its own power supply.

21. A pluggable peripheral device according to claim 18, including:
a plug having the complementary connectors,
a lead and
the device per se at the remote end of the lead.

22. A pluggable peripheral device according to claim 21, wherein the device is a touch-sensitive, visual-display unit.

23. A pluggable peripheral device according to claim 18, wherein the connectors and the complementary connectors are pins and sockets.

24. A pluggable peripheral device according to claim 23, wherein the ports are provided with male pins.

25. A pluggable peripheral device according to claim 23, wherein the ports are provided with female sockets, with the complementary connectors being pins.

26. A pluggable peripheral device according to claim 20, wherein:
the or each downstream, serial-bus port has the following contact numbering:
1. Ground
2. Serial Bus data +ve
3. Serial Bus data −ve
4. Ground
5. 3.3 volts
6. 2.5 volts
7. 2.2 volts
8. 1.8 volts
9. 1.2 volts
10. 1.0 volts
11. 0.9 volts
12. 0.7 volts
13. Spare
14. 5.0 volts and
the pluggable peripheral modules are provided with contact sockets 1 to 4 and 5 or 14, together with anyone of contact sockets 6 to 12 as required for voltage to operate their electronic device(s).

27. A pluggable peripheral device according to claim 20, wherein:
the or each downstream, serial-bus port has the following contact numbering:
1. Ground
2. Serial Bus data +ve
3. Serial Bus data −ve
4. Ground
5. 3.3 volts
6. 2.5 volts
7. 2.2 volts
8. 1.8 volts
9. 1.2 volts
10. 1.0 volts
11. 0.9 volts
12. 0.7 volts
13. Spare
14. 5.0 volts and
the pluggable peripheral modules are provided with contact sockets 1 to 4 together with 14 only or 5 only may be provided, where the circuitry of the module does not require a voltage lower than the predetermined voltage.
